(19) United States
(12) Patent Application Publication
(10) Pub. No.: US 2006/0149577 A1
(43) Pub. Date: Jul. 6, 2006

(54) System and method for the customized processing of returned merchandise

(75) Inventors: Edward J. Stashluk JR., Austin, TX (US); Terrance J. Combs, Cedar Park, TX (US); Douglas J. Kern, Austin, TX (US); Janet M. Mitchell, Austin, TX (US); Tushon Robinson, Pflugerville, TX (US); Paul A. Trulove, Austin, TX (US)

Correspondence Address: BAKER BOTTS L.L.P., 2001 ROSS AVENUE, SUITE 600, DALLAS, TX, 75201-2980, US

(73) Assignee: Newgistics, Inc.

(21) Appl. No.: 11/042,378

(22) Filed: Jan. 25, 2005

Related U.S. Application Data
(60) Provisional application No. 60/640,845, filed on Dec. 30, 2004.

(51) Int. Cl. G06Q 99/00; G07B 15/00; G07B 15/02

(52) U.S. Cl. 705/1; 705/13

(57) ABSTRACT

A system and method for providing macro based returns services that may be customized for particular retailers, customer or items. Forward files may be used to trigger particular actions in the return process. Analytics may be gathered and used to differentiate customers utilizing the returns process in order to optimize the retailers business and evolve the relationship with the customer. Customer information and information specific to the retailer or items can also be used to drive customized marketing initiatives triggered during the returns process.

### RELATED APPLICATION

This application claims benefit under 35 U.S.C. § 119(e) of U.S. Provisional Application Ser. No. 60/640,845, entitled “System and Method for the Customized Processing of Returned Merchandise,” Attorney's Docket 067439.0176, filed Dec. 30, 2004.

### TECHNICAL FIELD

The present invention relates in general to electronic commerce transactions and, more particularly, to a method and system for the customized processing of returned merchandise.

### BACKGROUND

The Internet and World Wide Web are especially conducive to conducting electronic commerce. Many Web servers and applications have been developed through which vendors can advertise and sell product. The products can include items that are delivered electronically to the user over the Internet and items that are delivered through conventional distribution channels (e.g., a shipping agent). A server computer system may provide an electronic version of a catalog that lists the items that are available. A user may browse through the catalog using a browser and select various items to purchase. When the user has completed selecting items to be purchased, the server computer system then prompts the user for information to complete the ordering of the items. The server computer system then typically confirms the order by sending a confirming web page to the client computer system. A file may be then be stored in a database associated with the server that includes user information, preference information, and order information.

In addition to security concerns, purchasing items over the Internet has forced many changes in habit for shoppers that accustomed to the experience of interacting with customary brick and mortar stores. For example, Internet shoppers are not able to pick up, try on, or otherwise interact with merchandise available for purchase. Additionally, Internet shoppers are subject to significant changes in the procedures necessary to return an item purchased on-line. Specifically, while some brick and mortar stores with Internet counterparts accept the return of merchandise purchased from their Internet counterparts, this is certainly the exception rather than the rule. Therefore, many Internet shoppers are faced with the logistical difficulties of having to return remotely purchased merchandise to a warehouse or returns facility operated by the Internet retailer.

There exists a myriad of issues with which an Internet customer must contend to return this remotely purchased merchandise. For example, these issues include whether the item is returnable, how will the refund be paid, what shipping agent should be used, how efficient is the long distance returns process, and what happens if the package is lost or damaged in transit. As an additional complication, customer loyalty, including finding and keeping customers is one the highest priorities for retailers. Retention rates for e-commerce retailers range from 50 to 66 percent. Thus, half to a third of all purchasers never buy from a retailer after their first encounter. The processes used by retailers to enable a customer to return merchandise play a key role in customer retention. First-time buyers who are disappointed with their first e-commerce or first experience with a particular retailer are not likely to shop with that retailer again. Furthermore, twenty-percent of all Internet-based purchases are returned to the retailer, thereby resulting in increased expenditures and dedication of resources by the e-commerce retailer. These and many other issues are currently contributing to the limited acceptance that Internet commerce has experienced.

### SUMMARY

The present invention provides a method and system for the customized processing of returned merchandise that substantially eliminates or reduces at least some of the disadvantages and problems associated with previous methods and systems.

Certain embodiments of the present invention may provide a number of technical advantages. For example, according to one embodiment of the present invention, a technical advantage may be the provision of retailer-specific, customer-specific, or item-specific return services. For example, a returns server may operate using a any number of appropriate macros to provide rules-based returns processing that are initiated by the occurrence and detection of a triggering-event. In particular embodiments, the triggering-event may include the receiving of additional information from a customer, a retailer, a carrier, or another party relevant to the returns process. The action performed at the occurrence of the triggering-event may include the a customized communication directed at the customer, the retailer, the carrier, or other relevant party. Accordingly, an advantage may be that return visibility may be improved to all parties interested in the processing of a returned item.

Another technical advantage may be that a retailer may provide customer and/or transaction information to a returns service provider in advance of the requirement for return services with regard to an item of merchandise. The customer and/or transaction information may include a forward file that may be leveraged to provide return services. As a result, returns processing may be customized to the particular customer. For example, a technical advantage may be that the forward file associated with a customer may be used to generate one or more personalized communications to a customer of a particular retailer. As another example, the forward file associated with a customer may be used to correlate an issued return label with a customer. Customized return services may then be offered when a triggering-event associated with the return label is detected.

Still another advantage may be the generation of return analytics on a customer-specific basis. In particular embodiments, each customer's purchase history, returns history, or a combination of both may be used to categorize the customers of a remote retailer into one or more pre-defined categories. The categorization of the customers may then be used to identify an appropriate marketing scheme to be applied to the customer. For example, the categorization of a customer may result in the offering of a promotion intended to improve customer retention or customer satisfaction. Thus, in this manner returns marketing efforts can be customized on customer-specific level.

Another technical advantage may be the generation of return analytics on a retailer-specific basis. For example, customer behavior may be used to determine a systemic linkage between returns behavior and purchase behavior. As a result, customer behavior and information provided at the time of a return may be used to determine the linkage between customer retention, average order value, order frequency, and return services provided. The results of the return analytics may then be used to define appropriate returns marketing measures for the improvement of a customer segment.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an exemplary return path that includes multiple intermediate locations for the processing of a return package and the gathering of information about the return package, according to one embodiment of the present invention;

FIG. 2 illustrates an exemplary return label for returning an e-commerce item in accordance with one embodiment of the present invention;

FIG. 3 illustrates a data string that is an example of the contents of the machine readable data on an exemplary return label according to one embodiment of the present invention;

FIG. 4 illustrates an exemplary returns system for facilitating the return of goods purchased by a customer from a remote retailer;

FIG. 5 is chart illustrating different types of customers participating in e-commerce transactions; and

FIG. 6 depicts an exemplary return analytics report that may be generated by the returns server to provide solid quantification of the impact of returns system on customer loyalty.

### DETAILED DESCRIPTION

The advantages of various example embodiments of the present invention are best understood by referring to the FIGS. 1-6 of the drawings, like numerals being used for like and corresponding parts of the various drawings.

A customer purchasing an item on the Internet, by catalog, or by phone may desire to return the item for a variety of different reasons. As just a few examples, an item may be returned if it is the wrong size, the wrong color, different than expected or described, broken, defective, delivered too late, or simply no longer wanted. Generally, a return shipping label may be provided to a customer who desires to return an item. In various embodiments, the return shipping label includes machine-readable information, such as a barcode, that may be scanned at various points during shipping and processing to provide valuable information to the customer initiating the return, the remote retailer from whom the goods were purchased, and/or any other interested party. The information may include item specific information, package specific information, customer specific information, tracking information, and/or any other information that allows the interested parties to process, manage, or facilitate the return. In particular embodiments, return analytics may be gathered on a customer or a group of customers. The return analytics may enable a remote retailer providing goods to customers on the Internet, by catalog, or by phone to implement segment-based marketing programs, offer dynamic pricing and/or personalized promotions, and improve customer retention and satisfaction.

The Return Path and the Return Label

During the transportation of a returned item from the customer, the returned item may be handled by a number of parties or entities and may pass through a number of intermediate locations while in route to its final destination. FIG. 1 illustrates an exemplary return path 10 that includes multiple intermediate locations for the processing of a return package 12 and the gathering of information about return package 12. In the illustrated example, return path 10 begins at a customer location 14. Depending on the various embodiments implemented, return package 12 may be delivered to customer location 14 by way of a standard carrier service such as the United States Postal Service, United Parcel Service, Federal Express, DHL, or another carrier. For one or more reasons that may include those listed above or any other reason that results in customer dissatisfaction, it assumed that the customer associated with customer location 14 desires to return one or more items contained in return package 12 for a credit.

As will be described in greater detail below, the customer associated with customer location 14 may initiate the return process in any of a number of ways. As a result of the initiation of the return process, a return label may be provided to the customer. In particular embodiments, for example, the return label may be mailed or emailed to the customer. In other embodiments, the return label may be generated using a web application. The web application can be provided by a merchandise return service or the remote retailer from where the returned items originated. In still other embodiments, the return label may be provided to the customer in the original packaging with the items purchased from the remote retailer. For example, the return label may be shipped to the customer with the merchandise as an independent item within the package or as an attachment to an order invoice.

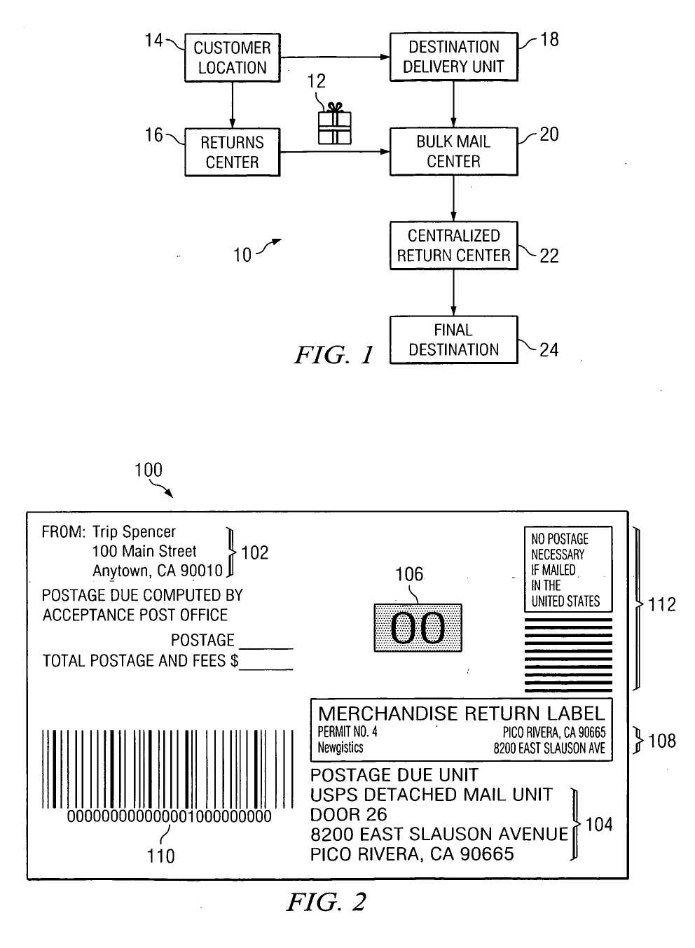

An exemplary return label 100 suitable for use in shipping return package 12 from customer location 14 to a final destination 24 is illustrated in FIG. 2. In the example of FIG. 2, the carrier is the United States Postal Service (USPS). However, other or additional carriers may be used for the routing of return package 12 on return path 10, and return label 100 may be modified to comply with the requirements of those carriers. Return label 100 incorporates data appropriate for implementing a merchandise return service, as well as data used for additional services provided by a returns provider. In general, the data incorporated in return label 100 may be used to make the returns process run more efficiently and satisfactorily from the perspective of both the customer and the retailer. For example, as will be described herein, the periodic tracking of the returned package can provide the retailer with information about the return that can enable the retailer to prepare for the arrival of the package or route it intelligently or enable the retailer to interact with the customer requesting the return very quickly by sending messages to the customer that could include marketing material or other information.

Return label 100 is preprinted to indicate at least the destination for the item and the package origin (the point where the customer places the package with a carrier). Typically, the destination and origin are identified by addresses, including postal codes. For purposes of this description, “postal codes” include the ZIP (zone improvement plan) codes of the USPS and similar codes used in other countries. Specifically, the customer's address is provided as the origin address 102 and is printed on the upper left corner of return label 100. This address matches the original delivery address of customer location 14. The destination address 104 may be that of a carrier center, such as a USPS bulk mail center (described in more detail below), where it is held for pickup by the returns provider.

Return label 100 is also preprinted with a visual flag 106 that comprises a human readable code. Visual flag 106 may be used for various purposes. For example, in particular embodiments, visual flag 106 is a destination code that indicates a final destination 24 of return package 12. Examples of final destinations 24 are a remote retailer's warehouse, a liquidator, or a warranty, recall, or repair center. In other embodiments, visual flag 106 may identify a business “rule” of the remote retailer from where return package 12 originated. As another example, visual flag 106 may indicate a quality of service, such as whether return package 12 is to be expedited or held for some reason. As still another example, visual flag 106 may indicate the contents of return package 12, such as whether it is “high value” for special handling. Additionally or alternatively, visual flag 106 may permit return package 12 to be manually sorted at a returns center 16 (illustrated in FIG. 1) for subsequent routing. The examples set out above for the use of visual flag 106 are retailer-specific, however, in the sense that visual flag 106 is specific to a particular retailer and its returns processing rules.

A merchandise return rectangle 108 is specific to the carrier and pertains to the relationship between the carrier and the returns provider. For example, in the illustrated embodiment, return rectangle 108 includes the USPS permit number associated with Newgistics, Inc., a returns provider. Return rectangle 108 also includes information associated with the returns provider such as the address of the returns provider.

In particular embodiments, return label 100 is also preprinted with dynamically generated machine readable data 110 that may represent unique information about the specific transaction involving the item(s) being returned. For example, machine readable data 110 may include information associated with the item(s) in return package 12, return package 12 itself, an order associated with returns package 12, a remote retailer from where returns package 12 originated, customer information, or any combination of this or other appropriate information. As will be described in more detail below with regard to the returns provider system, machine readable data 110 provides data for one or more returns servers so that various “value added” returns processing tasks may be performed. Such tasks may include the manifesting of shipping charges, notifications to the customer and/or remote retailer of the pending return, and final disposition of the returned item.

In particular embodiments, machine readable data 110 also includes a purchase transaction identifier. The purchase transaction identifier permits a returns server or returns service provider to correlate the items in return package 12 with an original purchase transaction between the customer and the remote retailer. Example types of purchase transaction identifiers include an invoice number, an order number, a transaction number, a customer number, and/or a retailer identifier. Although machine readable data 110 is illustrated as including alphanumeric or numeric formats, various other types of machine readable coding may be used as an alternative to bar-coding. For example, it is recognized that return label 100 may include optical scan data or radio frequency identification (RFID) tagging in addition to or in lieu of the bar code illustrated in FIG. 2. The coding may be printed or may be some other format, such as the electronic circuitry used in an RFID tag.

Where reverse manifesting is utilized, return label 100 includes a “postage due” insignia 112. Postage due insignia 112 includes both a human readable notation and machine readable data (horizontal bars) indicating to carrier personnel and equipment that “NO POSTAGE [IS] NECESSARY IF MAILED IN THE UNITED STATES.” Insignia 112 is appropriate where postage is to be paid by the retailer allowing the return of return package 12. Insignia 112 is also appropriate where postage is to be deducted from the credit issued to the customer upon receipt and approval of return package 12 by the returns service provider.

It is generally recognized that machine readable data 110 is retailer specific and may be configured to support the unique needs of each retailer. Accordingly, both the length and content of machine readable data 110 may be determined by retailer 304. For these reasons, machine readable data 110 may be said to comprise a “flexible barcode.” For example, retailer 304 may specify to returns server 306 what information should be encoded in machine readable data 110, and machine readable data 110 may be configured to include as much or as little information as retailer 304 determines is useful to the returns processing of the retailer's merchandise. This flexibility allows machine readable data 110 to accommodate very lengthy product numbers such as the EIN number associated with cell phones. Furthermore, due to the flexibility granted to machine readable data 110, the machine readable data 110 on a return label 100 associated with retailer 304 may include different information than similar machine readable data on a return label associated with another retailer even though both retailers may subscribe to return services provided by a return service provider.

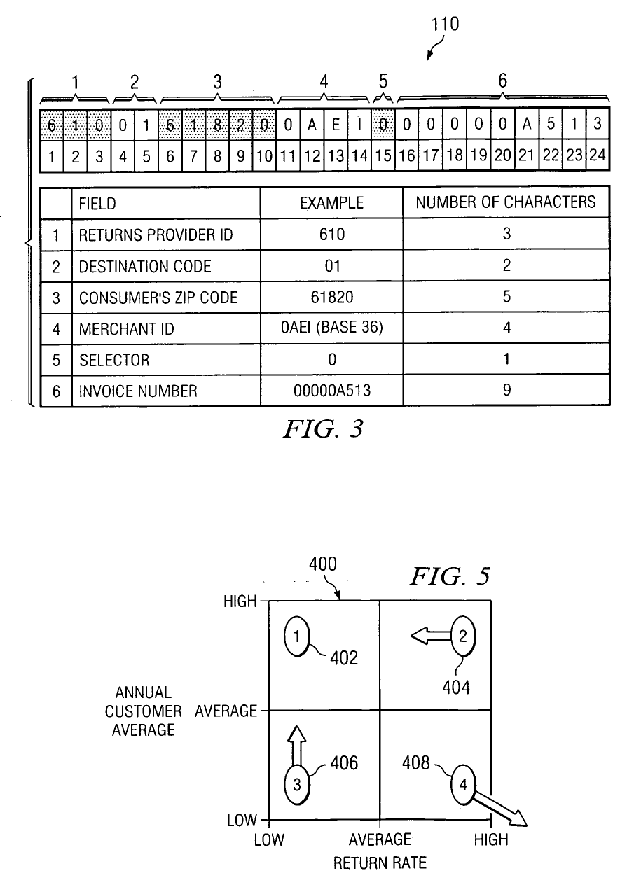

FIG. 3 illustrates a data string that is an example of the contents of the machine readable data 110 of FIG. 2. The example of FIG. 3 has twenty-four positions, each with an alphanumeric character. The information in machine readable data 110 is “integrated” in the sense that it is contained in a single barcode or other machine readable string of data. Machine readable data 110 contains multiple data points, and contains data that is “transaction specific”, in the sense that it identifies the transaction between the customer and the retailer or other party to whom the package is being delivered. The “transaction specific” data is dynamically generated in the sense that it is generated after the original order is made, and is specific to that transaction. Machine readable data 110 is considered a “third party barcode” in the sense that machine readable data 110 is not particular to, issued by, or of general interest to the carrier, which in this case, is the USPS. Although not shown in FIG. 2, return label 100 may have one or more additional barcodes, for example a barcode containing data for the carrier's use, such as for carrier tracking or return confirmation.

In general, machine readable data 110 includes one or more fields that may be used to store identifying information specific to the transaction, order, invoice, purchased items, customer, and/or retailer. For example, in the illustrated embodiment, machine readable data 110 includes six fields. Field 1 is used to identify the returns provider. Field 2 identifies a package destination by code. Field 3 identifies the customers' zip code or another identifier of the shipping origin of return package 12. Where reverse manifesting is utilized, field 3 permits assessment of shipping charges from where the customer drops off the package (the return package origin) to centralized returns center 22 or a nearby bulk mail center (“BMC”) 20 where return package 12 is pulled from the carrier. Field 4 identifies the retailer from whom the item was purchased or, where appropriate, a party other than the retailer who may be involved in the transaction leading to the return, such as a warranty or repair service. Field 5, a selector field, may be used for various purposes, such as to identify the label type, or to identify a shipping category, such as Priority Mail or customer-paid. Finally, field 6 identifies the transaction involving the returned item in some manner. This is typically the purchase transaction, such as in the case of a customer returning recently purchased goods. This terminology is used herein for sake of consistency. This sixth field is used to correlate the return label to the original order, such as by filling the field with a purchase transaction number, invoice number, or order number. This field may alternatively be used for data such as a customer number, product number (such as an SKU), or other transaction related data.

If desired, one or more of the above-described fields could be omitted and another field used to link to the same information or other information at a returns center. For example, Field 3 (the customer's postal code) could be omitted and Field 6 used at the returns center to dynamically link to stored data that provides the customer's postal code. In this event, machine readable data would equivalently be considered to contain “data representing at least the origin of the package and identification of the transaction.”It should be understood that machine readable data 110 in the example of FIG. 3 is minimal and additional data could be easily included. Additional data points that may be included in the machine readable data 110 include data points falling into categories “transaction specific,” “retailer specific,” “customer specific,” “product specific,” “trading partner,” or “disposition” data. “Transaction specific” data identifies the transaction, such as by invoice number, transaction number, or order number in the case of a purchase transaction. “Retailer specific” data identifies the retailer or some characteristic of the retailer. “Customer specific” data identifies the customer or some characteristic of the customer. “Product specific” data identifies the package contents, such as by SKU number. “Trading partner” data describes a trading partner of the returns center, such as a liquidator or other service provider. “Disposition” data describes a rule for the final disposition of the returned item.

In the example return label of FIGS. 2 and 3, the data on returns label 100 is pre-printed. In other embodiments, the customer might fill in at least some of this data. For example, returns label 100 could have a predetermined format, and the customer would be directed to fill in certain information such as the customer's address, the package invoice number, or a shipping destination. However, in general, regardless of whether returns label 100 is entirely pre-printed or partly filled by the customer, it is deemed to have a predetermined format, and prior to being shipped by the customer, to contain certain customer data as discussed in connection with FIGS. 2 and 3.

The retailer may provide return label 100 (or data for generating the return label 100) directly to the customer. Depending on the embodiment implemented, return label 100 may be emailed to the customer or mailed to the customer. Alternatively, return label 100 may be provided to the customer in the original packaging used to ship the items from the retailer to the customer. To this end, the returns provider provides the label specifications to the retailer, as well as a delivery address data file. This data file is used to correlate each customer's postal code to the returns provider location that is closest to the customer. As will be described in more detail below, the data file may be made available to the retailer and/or customer via data network access, such as by the Internet.

After return label 100 is provided to the customer at customer location 14, return label 100 may be adhered to or integrated into the return packaging and used to ship return package 12 back to the originating retailer or to an entity providing returns management services. Returning to FIG. 1, depending on the return system implemented or the customer's preference, return package 12 containing the returned item(s) may be deposited with a returns center 16. Returns center 16 may include a brick and mortar store that operates as a representative or agent of the retailer who sold the item to the customer. Alternatively, returns center 16 may operate as a representative or agent of one or more common carriers. For example, returns center 16 may comprise a Mailboxes, Etc., a United Parcel Service (UPS) store, a Federal Express (FedEX) store, or another storefront for receiving and shipping packages. In other embodiments, return package 12 may be placed in the mail or deposited with a destination delivery unit (DDU) 18. In particular embodiments, DDU 18 comprises a United States Post Office. Thus, return package 12 may be taken by the customer to a convenient post office and left for routing and delivery to its final destination.

Return package 12 may then be routed from either returns center 16 or DDU 18 to a Bulk Mail Center (BMC) 20. Return package 12 is typically delivered to the BMC 20 that is closest to the location of the next destination of return package 12. Thus, in the illustrated embodiment, return package 12 may be delivered to the BMC 20 that is closest to centralized return center 22. BMC 20 handles what is generally known as bulk mail, which includes second and third class mail and parcel post, as well as carton goods. Bulk mail typically includes books, magazines, advertising which may be in tied bundles, and small parcels.

A returns service associated with centralized return center 22 may pick up return package 12 and other accumulated packages addressed to it and transport return package 12 to centralized returns center 22. Alternatively, the common carrier may deliver return package 12 directly to returns center 22. In either case, the destination address on return label 100 is considered to be the centralized returns center 22 that is closest to customer location 14. Centralized returns center 22 may operate to receive and process return package 12. In the course of such processing, return package 12 may be acknowledged, inspected, and evaluated. For example, the condition of the returned products may be evaluated and return package 12 routed to an appropriate final destination 24 based on the condition of the returned package 12 and any retailer-specific disposition rules in place. Where the retailer's rules so provide, centralized returns center 22 may palletize return package 12 with other like items for a bulk shipment to final destination 24.

At each intermediate location between customer 14 and final destination 24, information may be gathered about return package 12 and communicated to interested parties for the processing and management of the return. For example, at one or more of the intermediate locations illustrated in FIG. 1, a scan of return label 100 may be performed. In particular embodiments, the scan of return label 100 may allow a returns provider to inform the retailer of the pending return. In a particular example scenario, a scan of machine readable data 110 may be performed to obtain identifying information about return package 12. Alternatively, the scan may be of a carrier-specific bar code that may then be used to correlate return package 12 to machine readable data 110. Machine readable data 110 may then be used to identify an invoice number, order number, customer number, retailer number, or purchase transaction. The identifying information provided by the scan of return label 100 may be used to provide advance return notification to the retailer to notify the retailer of the shipment of return package 12.

The scan of machine readable data 110 or a carrier specific bar code provided on return label 100 may additionally or alternatively be used to generate communications to the customer associated with return package 12. Such communications may include messages notifying the customer of the receipt of return package 12 at any one of the intermediate locations on the returns path 10. Additionally or alternatively, the communications to the customer may include personalized or general marketing or promotions, customer surveys, or other merchandise or transaction related messages.

System Architecture

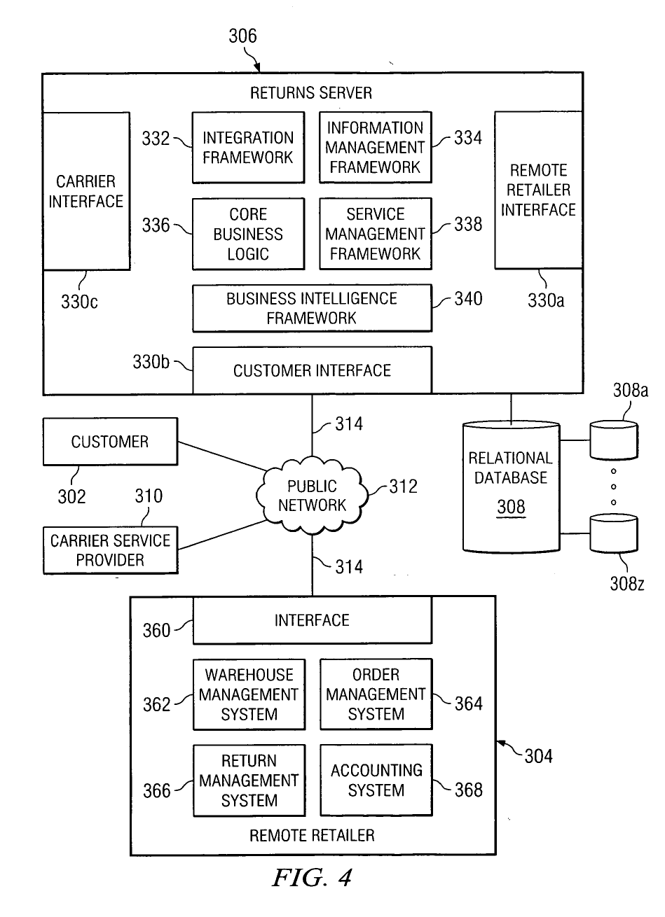

FIG. 4 illustrates an exemplary returns system, indicated generally at 300, for facilitating the return of goods purchased by a customer 302 from a remote retailer 304 or other retailer. Returns system 300 comprises a returns server 306 that stores order information, customer information, and other returns-related information in a relational database 308. Returns server 306 includes any suitable combination or arrangement of logic operating to support return services to remote retailer 304 and customer 302. In particular embodiments, returns server 304 maintains order and transaction information, maintains customer information, and manages various aspects of the return process, as described in further detail below. Although many functions of returns system 300 will be described as pertaining specifically to returns server 306, the same functions may be performed by another element of returns system 300 or by an element external to returns system 300.

In the embodiment illustrated, returns server 306 includes one or more interfaces 300, an integration framework 332, an information management framework 334, core business logic framework 336, service management framework 338, and business intelligence framework 340. During operation, returns server 306 executes event triggered or scheduled value-added-services for returns management via the many frameworks of returns server 306. Each framework may include a set of macros that are designed to automatically provide a suite of customized return services by customer type, customer value, type of product being returned, and/or other business rules. In operation, returns server 306 provides individualized return services such as returns process initiation, return label creation, returns communications, returns tracking, and other services. Returns server 306 manages the execution of the returns management services through the lifecycle of the return.

Returns server 306 includes at least one interface 330 for communicating with other elements of returns system 300. Although a single interface 330 may communicate with multiple elements of return system 300, returns server 306 may include multiple interfaces 330a-330d and each interface 330a-330d may communicate with a specific element of returns system 300. In the illustrated embodiment, returns server 306 includes a remote retailer interface 330a for communications with remote retailer 304 of returns system 300. Remote retailer interface 330a links returns server 306 with remote retailer 304 through public network 312. Prior to and during the processing of return package 12, various communications may flow from returns server 306 to remote retailer 304 and vice versa. For example, and as will be described in more detail below, interface 330a may receive data sets known as “forward files” that may contain customer information, purchase transaction information, and retailer information prior to the initiation of the return of return package 12. After the initiation of return package 12, interface 330a may transmit communications to remote retailer 304 to notify remote retailer 304 that the return of return package 12 is anticipated and/or pending and to provide remote retailer 304 with return analytics.

Interfaces 330b and 330c may operate similarly to interface 330a. For example, interface 330b may comprise a customer interface for receiving and transmitting communications between customer 302 of returns system 300 and returns server 306. Customer interface 330b links returns server 306 with customer 304 through public network 312. Examples of communications that may be transmitted between customer 304 and returns server 306 include return authorization requests and return merchandize authorizations (RMA), return status updates, and personalized promotions. As another example, interface 330c may comprise a carrier interface for receiving and transmitting communications between carrier service provider 310 and returns server 306. Carrier interface 330c also links returns server 306 with carrier service provider 310 through public network 312. Examples of communications that may be transmitted between carrier service provider 310 and returns server 306 may include communications of scan information, tracking information, and/or return label information.

Integration framework 332 performs operations related to file management, email management, web services, mapping, and cleansing. For example, for the performance of file management and email management operations, integration framework 332 includes document processing templates and macros that enable returns server 306 to process incoming information and communicate with other elements of returns system 300 using protocols outside of the standard protocol employed by returns server 306. Accordingly, integration framework 332 enables returns server 306 to communicate with remote retailer 304, carrier service provider 310, and customer 302 using File Transfer Protocol (FTP), HyperText Transfer Protocol (HTTP), HyperText Transfer Protocol Secure (HTTPS), Microsoft Message Queuing (MSMQ), or other suitable protocols even where the returns server's standard protocol comprises eXtensible Markup language (XML). Integration framework 332 is able to receive information from external sources and translate such information into, for example, XML format for processing internal to returns server 306. In addition, when information needs to flow out of returns server 306, integration framework 332 is able to translate internal XML formatted information into whatever format is needed by the receiving system, such as the formats listed previously.

Whereas integration framework 332 manages file integration and other file management services, information management framework 334 performs security functions. For example, information management framework 334 may provide encryption services for the secure communication of files and messages between returns server 306 and other elements of returns system 300. As another example, information management framework 334 may provide authentication and authorization services. Authentication provides a method of identifying users, including login and password dialog, challenge and response, messaging support, and, depending on the security protocol utilized, encryption. Authentication enables a customer 302, remote retailer 304, or carrier 310 to be identified before allowing access to return server 306 and return services. Authorization, on the other hand, allows for remote access control, including one-time authorization or authorization for each service. The authorization function may assemble a set of attributes that describe what the user is authorized to perform. These attributes may be compared to the information contained in relational database 308 or another database for a given user and the result may be returned to return server 306 to determine the user's actual capabilities and restrictions.

Core business logic 336 includes software or other logic that processes information received from customer 302, remote retailer 304, and carrier 310. In particular embodiments, core business logic 336 may include logic operable to convert data, files, documents, and/or messages from one format to another. Core business logic 336 may also include software or other logic that implements retailer-specific, customer-specific, and returns server-specific rules. Thus, where remote retailer 304 has registered with returns server 306 to provide personalized promotions to a particular segment of customers, core business logic 336 performs the generation of personalized promotions when the appropriate circumstances are present. Core business logic 336 may run macros or other time or event driven processes to initiate and perform return services offerings when triggered by a set of retailer rules or client or consumer specific characteristics. For example, where a message is received from a customer 302 requesting authorization of the return of return package 12, a return label 100, or another event-triggering communication, core business logic 336 may execute the embedded service request, schedule the service request for later execution, or queue the service request until an event triggering the service request is detected by returns server 306 Accordingly, depending on the various embodiments implemented, core business logic 336 provides the ability of returns system 300 to customize the returns experience on a per retailer basis, a per consumer basis, or a per return basis. For example, core business logic 336 may also provide different suites of return services based on customer type.

Whereas core business logic 336 includes the logic required to offer and perform return services, service management framework 338 provides provisioning operations. Accordingly, service management framework 338 operates to receive the requirements of retailer 304, identify the needs of core business logic 336, and provision the logic necessary to perform the return services requested by retailer 304 or a customer 302 of retailer 304. Provisioning is performed on a per retailer basis 304. For example, where retailer 304 subscribes to this return service, service management framework 338 may operate to schedule the pick-up of return package 12 at BMC 20. As another example, service management framework 338 may operate to set up the templates provided to customer 302, remote retailer 304, or carrier 310 for the entering and transmission of return information about return package 12. As still another example, where retailer 304 requests that email communications be delivered to customer 302 at the occurrence of triggering events, service management framework 338 may generate the macros and templates required for developing and delivering the email communications. The macros, templates, and other logic provisioned by service management framework 338 may be stored in relational database 308 until used by core business logic 336 to perform return services.

Returns server 306 may also offer returns analysis services performed by a business intelligence framework 340. Business intelligence framework 340 may operate to perform online transaction processing to extract, transfer, and/or load information stored in relational database 308 or another data warehouse. The extraction, transfer, and loading of information may result in return analytics such as the percentage of customers returning items, the frequency of returns on a per-customer basis, the frequency of returns on a per-item basis, or other analytics useful to a remote retailer 304 in determining general or specific customer satisfaction and retention. Particular return analytics offerings that may be provided by business intelligence framework 340 are discussed in more detail below.

While the embodiment illustrated and the preceding description focus on a particular embodiment of returns server 306 that includes specific elements, returns system 300 contemplates that returns server 306 may have any suitable combination and arrangement of elements for offering returns management services. Therefore, the modules and functionalities described may be combined, separated, or otherwise distributed among any suitable functional components, and some or all of the functionalities of returns server 306 may be implemented by logic encoded in media, such as software and programmed logic devices.

As described above, returns server 306 stores order information, customer information, and other returns-related information in relational database 308. In particular embodiments, relational database 308 includes multiple databases for storing returns related information. For example, relational database 308 may include a customer database 308a that stores customer-specific data. Customer database 308a preferably contains customer information for various users or potential users of return system 300. Customer information may include user-specific return information such as the name of the customer, credit information, and shipping information in a user preference profile. Additionally or alternatively, relational database 308 may include a transaction database 308b that contains information indicative of transactions associated with registered customers of remote retailer 304. A retailer database 308c may contain a listing of the various remote retailers, such as remote retailer 304, that participate in the returns services provided by returns system 300. The population of relational database 308 and associated databases 308a-z will be discussed in further detail below.

In the illustrated embodiment, remote retailer 304 includes one or more interfaces 360, a warehouse management system 362, an order management system 364, a returns management system 366, and an accounting system 368. Any one or all of these elements of remote retailer 304 may communicate with returns server 306 at any given time. For example, warehouse management system 362 may include software or logic for determining the services required by remote retailer 304 based on the return policies and return history associated with remote retailer 304. In particular embodiments, warehouse management system 366 include information relating to the inventory of retailer 304 and may make determine the services required by remote retailer 304 based upon the retailer's current inventory. The inventory information may identify the quantity of an item held as back stock, the quantity of an item on the shelves in one or more brick and mortar stores, the quantity of an item held for e-commerce sale, the quantity of an item in shipment to a customer, and any other appropriate information appropriate for the management of the retailer's inventory. The inventory information may be used to adjust shipping needs, to adjust manufacturing needs, to plan for warehouse storage, or to perform other inventory-based functions.

Order management system 364 maintains and manages order information as orders are received from customers such as customer 302. Order management system 364 may perform queuing, fulfillment, and other services required for the receiving and fulfillment of Internet, catalog, or telephone orders. As will be described in more detail below, order management system 364 may communicate with returns server 306 to provide returns server 306 with forward files that include order information for customers, such as customer 302. The forward files may be transmitted on a periodic basis, such that information about new customers and orders can be added to relational database 308. Returns server 306 may then offer return services for these customers and orders as is needed.

Accounting system 368 performs finance operations for remote retailer 304. For example, accounting system 368 may operate as credit clearinghouse to facilitate the initial purchase transaction between customer 302 and remote retailer 304. In particular embodiments, customer 302 may provide credit card information which may be used to approve or deny the transaction. Accounting system 368 may perform the credit clearinghouse functions or may send the credit card and customer information to an external credit clearinghouse that may then approve or deny the transaction after running a credit check on customer 302. Typically, remote retailer 306 waits until the credit transaction is approved before fulfilling the requested order. When communications are received from returns server 306 that indicate that a return is pending and/or authorized, accounting system 368 may be used in a similar manner to refund all or a portion of the customer's payment. In particular embodiments, accounting system 368 may communicate to returns server 306 that a refund has been issued so that returns server 306 may notify customer 302 of the credit.

While the embodiment illustrated and the preceding description focus on a particular embodiment of remote retailer 304 that includes specific elements, returns system 300 contemplates remote retailer 304 having any suitable combination and arrangement of elements for registering for and receiving returns management services. Therefore, the modules and functionalities described may be combined, separated, or otherwise distributed among any suitable functional components, and some or all of the functionalities of remote retailer 304 may be implemented by logic encoded in media, such as software and programmed logic devices.

In the illustrated embodiment, system 300 also includes one or more carrier service providers 310. As discussed above with respect to return path 10 of FIG. 1, carrier service provider 310 performs some or all of the transportation of return package 12 from customer location 14 to centralized returns facility 22 or final destination 24. For example, carrier service provider 310 may include USPS, UPS, DHL, Federal Express, or another common carrier for the shipment of parcels from customer location 14 at least as far as BMC 20. As will be described below, carrier service provider 310 may obtain information from or provide information to other elements of returns system 300. For example, returns server 306 may obtain real-time, daily, or other periodic updates from carrier service provider 310 that includes information obtained from a scan of return label 100. Information provided to returns server 306 from carrier service provide 310 allow the returns service provider to provide notifications to customer 302 and remote retailer 304 of a pending return.

Remote retailer 304, customer 302, and carrier service provider 310, communicate with returns server 304 through a public network 312 and one or more communication links 314. In the disclosed embodiment, remote retailer 304 and customer 302 may comprise personal computing devices or any other suitable type of computers or electronic devices that are coupled to communications links 314. Public network 312 may comprise any computer network such as the Internet, an extranet, or other known or hereinafter developed network for the communication of data. As technical background, the Internet is a world wide network of networks that links many computers through many separate, but inter-communicating, networks. Using the Internet, users can access vast amounts of stored information and establish communication with other Internet capable computers or other communications and processing devices. In the returns context, a customer, a retailer, or a returns provider can use the Internet to access information relating to a purchase transaction associated with return package 12 stored in relational database 308 and to communicate relevant messages and files.

Forward Files

As described above, communications from remote retailer 304 to returns server 306 may be used to populate and/or update the information stored in relational database 308 on a periodic basis. In particular embodiments, remote retailer 304 may supply returns server 306 with up-to-date customer and transaction information on an hourly, daily, weekly, monthly, or other periodic basis. For example, over the course of a twenty-four hour period, remote retailer 304 may acquire any number of new customers through Internet, telephone, and/or catalog purchase transactions. Remote retailer 304 may accumulate the customer and transaction information associated with these new purchase transactions and provide the information to returns server 306 on a daily basis. In particular embodiments, the frequency at which remote retailer 304 provides customer and transaction information to returns server 306 may depend upon whether remote retailer 304 comprises a high volume seller or a low volume seller. The higher the volume sold by remote retailer 304, then the more frequently returns server 306 may receive or access the information. In some instances, the information may be provided to remote retailer 304 at a real-time rate as orders are received or processed by remote retailer 304. Thus, forward files may constantly be added to relational database 308. Regardless of whether the files are received on a periodic basis or on a real-time basis, the files are received in advance of a return notification from a customer. For this reason the files have been termed “forward files.”

Regardless of the frequency at which remote retailer 304 updates relational database 308, it is only critical that remote retailer 304 have the information needed to perform returns processing when customer 302 receives the merchandise from remote retailer 304. Without the information, returns server 306 may not be able to process the return in a timely manner at the cost of customer satisfaction and reduced customer retention.

In particular embodiments, the customer and transaction information embodied in the forward file may be communicated from remote retailer 304 to returns server 306 as a file transfer. In other embodiments, returns server 306 may access a database of remote retailer 304 and extract the updated information and files. Returns server 306 may then store the updated information in relational database 308 where it may be held for a predetermined amount of time in accordance with the remote retailer's return policies. Alternatively, the information may be stored in relational database 308 for a longer period of time for the performance of return analytics. Because the information and files are provided to or acquired by returns server 306 based on the completion of a purchase transaction rather than based on the initiation of a return by customer 302, the information provided to server 306 for the population of relational database 308 and associated databases may be termed a “forward file.”Returns server 306 may leverage the forward files to provide return services to remote retailer 304 for returns by customer 302. For example, when a customer 302 communicates a desire to return package 12 to remote retailer 304, returns server 306 may use appropriate templates and macros for obtaining information from customer 302. The customer information may include identifying information that is used to verify the authenticity of customer 302. Additionally, the customer information may include information that returns server 306 may use to identify an order, invoice, or item that is associated with a return request from customer 302. Returns server 306 may then use files stored in relational database to authorize the return in accordance with the remote retailer's policies and to correlate the order, item, or customer information with a return label 100 where appropriate.

As another example, forward files may be used to correlate an issued return label 100 with a customer, order, item, and/or retailer using the machine readable data on return label 100. As discussed above with regard to FIG. 2, return label 100 may include both machine readable data 110 that is used by returns server 306 to provide return services and a carrier-required bar code. For the generation of a return label 100 and the provision of return label 100 to customer 302, carrier 310 may agree in advance to provide return shipping services to remote retailer 304. In particular embodiments, carrier 310 may provide remote retailer 304 with a field of carrier-required bar codes and allow remote retailer 304 to issue them to customer 302 as needed. When remote retailer 304 issues a return label 100 to customer 302, remote retailer 304 may maintain a record of identifying data of return label 100 and correlate that data with customer 302. Similar to order and customer information, return label information may accumulate over a period of time. Accordingly, remote retailer 304 may provide this information to returns server 306 on a periodic basis. The information may be incorporated into the forward files discussed above. Alternatively, remote retailer 304 may provide the return label information in a separate forward file that is available to returns server 306 or provided to returns server 304 on a periodic basis that may be the same as, more frequent, or less frequent than the forward files discussed above.

Label information maintained by returns server 306 in relational database 308 or another database may then be used to provide return services that are triggered by the scanning of return label 100 at any one of the intermediate locations described with regard to FIG. 1. For example, when an item is received at DDU 18 or otherwise comes into the possession of carrier 310, a scan of any of the machine readable data on return label 100 may be performed. In particular embodiments, carrier 310 may scan the carrier-required bar code to provide tracking services to customer 302, remote retailer 304, and returns server 306. The time and date associated with the scanning of the carrier-required bar code, as well as the identifying information provided by the carrier-required bar code, may be provided to or made available to returns server 306. This information may be useful to returns server 306 for the provision of a number of returns services. For example, the scan information may be the first event that affirmatively identifies return package 12 as in return path 10 and as requiring the provision of return services by returns server 306. When returns server 306 receives notice that return package 12 is in return path 10, returns server 306 may then perform any operations necessary to initiate the processing of the return of return package 12. In particular embodiments, and as will be described in more detail below, returns server 306 may proceed by generating one or more communications to customer 302 or remote retailer 304 to provide status information, tracking information, or promotions information.

Customer Initiation of a Return—Return Merchandise Authorization

Until a customer initiates a return, the forward files provided to returns server 306 may remain unused in relational database 308 until returns processing is required. In particular embodiments, the customer associated with customer location 14 may initiate a returns transaction by accessing a web application on the Internet. The web application may be associated with the retailer from whom the item was originally purchased. Alternatively, the web application may be associated with a returns management system or company associated with returns server 306. The customer may be prompted to enter identifying information that may be used to authenticate the customer and/or identify and display a transaction listing. The transaction listing may include individual transactions indicative of merchandise purchased by the customer with detailed item descriptions. The transaction listing may identify the merchandise on an item-by-item basis or on an order-by-order basis. In particular embodiments, the customer may initiate the return transaction by selecting an item for return or by selecting an order that includes the item for return. Where the web application allows the customer to specify from a displayed list of transactions, orders or items, with a single action such as a single click of a mouse button, the item(s) to be returned return, the web application may be said to offer a “single-action return process.”The selection of an item or order from the transaction list may result in the initiation of the return and, in particular embodiments, the transmittal of a return request. The return request typically identifies the product to be returned and the reason for the return. The information provided by customer 302 may be used to determine whether the return should be validated. In particular embodiments, the validation of the returned item may be performed before a shipping label is provided to customer 302. In such instances, a credit may be issued to customer 302 before return package 12 is received at final destination 24 and may even be issued before return package 12 is received at centralized return center 22. In other embodiments, the validation of the returned item may be performed after return package 12 is received at final destination 24 or centralized return center 22.

Where return validation is performed when customer 302 accesses the web application described above and provides identifying information, a return validation code may be provided to customer 302. The return validation code may include one or more identifiers of remote retailer 304, a purchase date, product identification for the item(s) being returned, a purchase price, or any other information useful to the processing of a return. In particular embodiments, the return validation code may be provided to customer 302 through the web application, as an email, or in the standard mail. Alternatively, the return validation code may be integrated or associated with return label 100 and provided to customer 302 with return label 100 in any of the methods described above with reference to FIG. 2.

Upon receiving return label 100 and/or a return validation code, customer 302 may have options for placing return package 12 in transit. As examples, and as described above with regard to FIG. 1, customer 302 may directly deliver return package 12 to returns center 16 or to DDU 18. Where customer 302 delivers return package 12 to return center 16 and has been issued a return validation code, returns center 16 may verify the authenticity of the return validation code. However, this “drop off method” may be used with or without prior authorization as the policies of remote retailer 304 allow. In other embodiments, customer 302 may request carrier service provider 310 to pick-up return package 12. Depending on the particular embodiment implemented, this request may be transmitted through the web application described above or made directly to carrier service provider 310. For example, after customer 302 provides appropriate information online or via the telephone, carrier service provider 310 may be notified to pick up return package 12. Carrier 310 may then send a representative to pick up return package 12 from customer 302.

Advanced Return Notification

The information provided by the customer to initiate the return process and/or the information obtained from scanning return label 100 may be used to improve the flow of information to remote retailer 304. Specifically, as return package 12 is processed at any of the various locations included in return path 10, information may be communicated to remote retailer 304. In particular embodiments, the information provided to remote retailer 304 may include status and/or tracking information. For example, when return label 100 is scanned at DDU 18, returns center 16, BMC 20, or centralized return center 22 and scan information is provided to returns server 306, returns server 306 may generate a message that is electronically communicated to remote retailer 304 to inform remote retailer 304 of the location of return package 12 in return path 10. As another example, if a return validation process or other inspection process is performed at centralized return center 22, a message may be electronically communicated to remote retailer 304 to provide information relating to the condition of the items in return package 12 or even the contents of return package 12.

The communication of information to remote retailer 304 may be triggered according to retailer-specific rules that are managed and implemented by returns server 306. Thus, remote retailer 304 may specify in advance what information the retailer 304 would like to receive and when. The rules provided by remote retailer 304 may be customer-specific, item-specific, or transaction specific. For example, remote retailer 304 may have a rule that it is notified earlier or later in the return process of the pending return based on a categorization of the returning customer 302 as a high volume or low volume customer. As another example, remote retailer 304 may have a rule that it is to be notified earlier in the return process if the item being returned is a popular, high-demand item. In addition to the return notification rules being customizable, the return notification rules may be updated or revised by the implementation of new rules as remote retailer 304 deems appropriate.

Remote retailer 304 may use these and other communications from returns server 306 to make decisions about the disposition of the items in return package 12. For example, remote retailer 304 may receive a communication from returns server 306 when a scan is performed of return package 12 at centralized return center 22 that identifies return package 12 using the machine readable data 110 on return label 100 or by data gleaned from machine readable data 110. Remote retailer 304 may then determine, by analyzing its current inventory, received and unfulfilled orders, or other information, where return package 12 should be routed. For example, if remote retailer 304 determines that it has a high or low inventory of the returned item, is closing out the item, or is no longer offering the item for sale, retailer 304 may send a message to returns server 306 that results in the provisioning of a new retailer-based rule. If remote retailer 304 determines that it has a high inventory of the returned item, the new rule may result in the dispositioning of return package 12 or the item(s) in return package 12 to an outlet center or other discount center. On the other hand, if remote retailer 304 determines that it has a low inventory of the returned item (and the reason for the return provided by the customer did not question the quality or condition of the item), the new rule may result in return package 12 or the item(s) in return package 12 being shipped back to remote retailer 304 to be placed in inventory.

As still another example, if remote retailer 304 receives a communication when return package 12 is initially placed on return path 10 (i.e., at DDU 18 or returns center 16), remote retailer 304 may use the information in the communication to determine if return package 12 should be shipped directly to final destination 24 and not routed through centralized return center 22. Thus, in particular embodiments, remote retailer 304 may decide, in certain circumstances, to bypass the centralized return process. An example of when-such a determination might be appropriate includes the return of a back-ordered item that is in high demand by consumers. Where remote retailer 304 determines that such an item is being returned in return package 12, remote retailer 304 might send a command to the returns center 16 which can then direct the item to a retailer for placement in inventory or direct it as needed to fulfill the retailer's needs.

Additionally or alternatively, the communications may trigger remote retailer 304 to perform or authorize a credit to the account of customer 302. Even where a return validation code is provided to customer 302 prior to the placement of return package 12 in return path 10, the crediting of the customer's account may not occur until remote retailer 304 or returns server 306 receive a notification or other information that places return package 12 in return path 10. The delaying of crediting the customer's account prevents customer 302 from fraudulently requesting a return authorization and obtaining a credit without ever returning the item(s). Because advanced return notification is provided to remote retailer 304 before return package 12 is delivered to centralized return center 22 or final destination 24, however, customer 302 may be given a credit sooner by returns server 306 or remote retailer 304 than by returns systems that do not include advance return notification functionality.

Customer Notifications

The flow of information about the processing of return package 12 may also be directed at customer 302. For example, customer 302 may subscribe, using the web application described above, to receive tracking updates through email, mail, or another message format. Accordingly, when scan information is obtained by returns server 306 at any of the various locations on return path 10, an email or other message may be electronically transmitted to customer 302 to notify customer 302 that return package 12 has been received at a particular location. Additionally or alternatively, customer 302 may be given status updates on the return process. Thus, customer 302 may be notified when return package 12 is validated or inspected, when a credit is issued, or when the return process is completed.

In other embodiments, status and tracking information may be made available to customer 302 through the Internet. In such embodiments, customer 302 may use the web application described above or another Internet-based application to follow return package 12 on return path 10 and through the return process implemented at centralized return center 22. In this scenario, customer 302 may determine, to some degree, the amount of information customer 302 receives about return package 12.

Return Reason

Customer 302 may be required to provide a return reason when initiating the return process. The return reason may be given using the web application described above or to an operator at a call center where returns are initiated in that manner. In particular embodiments, the return reason may be encoded into machine readable data 110 on return label 100. Accordingly, the return reason may be made available to returns server 306 and remote retailer 304 before return package 12 is received and the item(s) in return package 12 inspected.

In particular embodiments, the return reason given by customer 302 may be used to validate or authorize the return. Thus, the return reason may be included in the request for authorization submitted by customer 302 prior to the placement of return package 12 in transit on return path 10. In particular embodiments, remote retailer 304 may process the return reason to determine if the return reason is compliant with the return policies of remote retailer 304. Where the remote retailer 304 identifies the return reason as noncompliant, return authorization may be denied. For example, assume that a remote retailer 304 has a policy that requires all items be returned within thirty days of purchase. If the return reason that is provided for an item indicates that the item broke after 60 days of use, remote retailer 304 may withhold authorization of the return. Instead, remote retailer 304 might direct customer 302 to a manufacturer of the item for warranty information or to a service center for the item.

Additionally or alternatively, the return reason given by customer 302 may be used to make decisions about the disposition of the item(s) in return package 12. For example, where the return reason given by customer 302 identifies the item as broken, returns server 306 may reference retailer specific return rules to determine that return package 12 or the item(s) in return package 12 should be transported to a service center, outlet center, or recycling center. Alternatively, returns server 306 may determine that the item(s) should be disposed of as waste and the incurrence of further costs relating to the processing or handling of the return prevented. As another example, where the return reason identifies the item as the wrong color, wrong item, or wrong size, remote retailer 304 may desire that the item be returned to inventory for resale.

Return Analytics

The return reason provided by customer 302 and other information gathered by returns server 306 may be used to perform return analytics for the purposes of returns marketing. The returns analytics performed by returns server 306 may include data-mining and analysis to determine the impact of returns and the returns process on purchase frequency, customer retention, and annual order value. The data provided by customer 302 and remote retailer 304 may be profiled to determine a linkage between return behavior and purchase behavior. As a result of the gathering and competitive processing of the information, remote retailer 304 may make informed business decisions to improve customer acquisition and retention.

On a customer-specific level, returns analytics may impact the remote retailer's management of the customer relationship. For example, the return history of customer 302 may be used in conjunction with the customer's purchase history to categorize customer 302 into one of a plurality of pre-defined categories. FIG. 7 is chart 400 illustrating different types of customers participating in e-commerce transactions. Specifically, chart 400 includes four types of customers categorized based on return rate and customer value. In particular embodiments, returns server 306 analyzes the purchase history and return history of customer 302 to place customer 302 into one of these or other categories. Future treatment of customer 302 by remote retailer 304 may be influenced by the categorization of customer 302.

Customers of a first type 402 include those customers that spend more and return less than the average customer of remote retailer 304. These are the best and most valued customers of remote retailer 304. Customer retention has not proven to be an issue with customers of the first type 402 as they have proven their loyalty to remote retailer 304. Additionally, remote retailer 304 has not expended excessive resources to process and handle returns for customers in this segment. For these reasons, customers of first type 402 may be termed “elite buyers.”

Customers of a second type 404 include those customers that spend more than the average customer but also have a high return rate. While these are not the best customers of remote retailer 304, remote retailer 304 may still value these customers because of their higher than average spending. Because they are high-frequency returners, however, customers of the second type 404 provide an area of growth and development for remote retailer 304. Improvement among these customers is desirable. For these reasons, customers of second type 404 may be termed “high maintenance customers.” Customers of a third type 406 include those customers that spend less than the average customer but don't return much of what they buy. These, too, are not the best customers of remote retailer 304. Nevertheless, remote retailer 304 values these customers since little resources are expended to process and handle returns for customers of third type 406. Because of the low annual purchase value of these customers, however, this type of customers may also provide an area of growth and development for remote retailer 304. However, the effort expended to develop customers of third type 406 may not provide to be a profitable investment. Nevertheless, customers of third type 406 may be termed “a growth segment.”

Customers of a fourth type 408 include those customers that spend less than the average customer and return much of what they buy. Customers of fourth type 408 are the least valued customers of remote retailer 304. Both customer loyalty and customer satisfaction are typically a problem for customers of fourth type 408. Whatever value that remote retailer 304 receives from customers of fourth type 408 is offset by the amount of resources used to process and handle returns for these customers. This type of customer also does not typically provide an area of growth and development that is worth pursuing. In fact, in particular embodiments, affirmative efforts may be taken to remove customers of fourth type 408 from the retailer's customer list. For these reasons, customers of fourth type 408 may be termed “problem customers.”

In addition to providing a categorization service, returns server 306 may also operate to implement communications and promotions programs and other actions designed to improve the status of customers based on the above or other categorizations. The following Table 1 describes promotions, communications, and other actions that may be taken by returns server 306 or remote retailer 304 to improve the status of customer 302 with respect to remote retailer 304. Accordingly, after returns server 306 operates to categorize customer 302 into a category, such as those described above, that helps to value customer 302 with respect to remote retailer 304, returns server 306 may be used to deliver timely and relevant marketing promotions and other communications.

TABLE 1

| Promotion | Focus | Description | Benefits |
|---|---|---|---|
| 1st Time | Retention | A timely, personalized return notification | Increased retention |
| Buyer | | email sent to 1st time buyers within 2-3 | rates among 1st |
| Program | | days of mailing the return, thanking them | Time Buyers, an “at |
| | | for their business and acknowledging that | risk” segment, by |
| | | the purchase didn't meet their expectations. | providing a timely |
| | | Includes a retention-focused offer, such as | communication. |
| | | a promo code for “10% off your next | |
| | | purchase” and a link back to the merchant | |
| | | web page. | |
| | | Promo code is tracked as part of regular | |
| | | Returns Analytics program. | |
| Store Traffic | Store Traffic | Providing local store information as part of | Increase store traffic |
| Program | | a customer's return notification, for | and store revenue. |
| | | returners within X miles of a retail store. | Maintain customer |
| | | The returner's zip code is used to match the | returns convenience |
| | | closest store location. | and return program |
| | | A coupon code is included for a XX % off | revenue. |
| | | your next store purchase. | |
| Elite Buyer | Retention | A “this return is free” thank-you promotion | A low-cost way to |
| Thank-You | | as part of their return notification, thanking | add additional |
| Program | | the customer for their continued business. | perceived value to a |
| | | Sent to the top 2% of customers based on | high-value customer |
| | | value, who have a return rate less than | segment. |
| | | average. | Can be combined |
| | | This is a low-cost retention-focused | with an existing |
| | | program, since this segment does not | Elite Buyer |
| | | return very often. | program. |
| | | Retention rate is tracked as part of regular | Higher retention |
| | | Returns Analytics program. | rates. |
| High | Customer File Migration | A survey for high-spending returners who | Decrease return |
| Maintenance | | have higher than average return rates, to | rate, and |
| Returner | | understand the common root causes for | particularly, return |
| Survey | | high returns among this segment. | dollars, among this |
| | | Survey delivered by outbound calls, mail | high value segment. |
| | | or email. | Increase |
| | | Recommendations and additional | profitability. |
| | | programs delivered at survey conclusion. | |
| Problem | Customer File Migration | Targeting the customers who buy at the | Increase the value |
| Returner | | bottom 5% level in revenue, but have a | of the overall |
| Identification | | higher than average return rate. | customer file. |
| | | The program cleanses these customers | Provide direction |
| | | from the customer file, removing them | for future list |
| | | from future mailings and promotions. | acquisition profiles. |

For example, through returns server 306 remote retailer 304 may implement a retention program with respect to customers falling within first type 402 (i.e., those customers with elite buyer status). Despite proven customer loyalty, it is a primary goal of remote retailer 304 to continue to retain customer 302 if customer 302 is a customer of first type 402. Accordingly, a message of gratitude may be communicated to customer 302. In particular embodiments, a “this return is free” promotion may be communicated to customer 302 when customer 302 accesses returns system 300 using the web application described above. Alternatively, the promotion may be communicated to customer 302 with return label 100 or at any other appropriate time during the return process. Even though remote retailer 304 pays shipping costs for the return of return package 12, the “this return is free” promotion is a low-cost retention-focused program since customers of first type 402 do not return items very often. Benefits incurred by implementing such a promotion program may include added perceived value to a high-value customer segment and, thus, even higher retention rates. This promotion may be combined with other elite buyer programs to provide added benefits to customer 302 and remote retailer 304.

A different type of program may be implemented with respect to customers falling within second type 404 (i.e., those customers with high maintenance status). In this customer segment, the primary goal is to decrease the customer's rate of return to improve profitability. Stated differently, the goal is to migrate customers of second type 404 toward the customers of first type 402 on chart 400. In particular embodiments, a survey may be communicated to customer 302 to obtain a greater understanding of the customer's return pattern and to detect common root causes for high returns among this segment. Similar to other communications to customer 302, server 306 may communicate the survey in an email, through the mail, or through a scripted live telephone conversation. The information obtained from the survey may supplement a return reason given by customer 302, where applicable, to determine if there are problems with the customer's perception of the retailer's goods and/or to identify reoccurring defects in the customer's purchasing decisions.

Examples of valuable information that may be obtained from a customer survey include information relating to misperceptions that the customer has about sizing (the customer repeatedly orders a size four when a size six is more appropriate) and information relating to mischaracterizations of a retailer's products on the retailer's Internet site (the retailer has sized its products wrong or doesn't provide accurate depictions of products). In particular embodiments, the survey may conclude with recommendations from customer 302, recommendations to customer 304, and/or the delivery of additional programs or promotions. Benefits incurred by implementing such a survey program may include a decrease in customer return rates and an increase in profitability.

As described above, it may be determined that no promotions program or retention program is needed with respect to customers falling within third type 406 since there aren't any real addressable problems identified with this segment. On the other hand, a reverse retention program may be implemented with respect to customers falling within fourth type 408 (i.e., those customers with problem returner status). In this customer segment, the primary goal may be to cleanse these customers from remote retailer's clientele. Accordingly, remote retailer 304 may implement an internal program to remove customers of fourth type 408 from mailing and promotion lists. As a result, the value of the retailer's overall customer file may be increased, and direction for future customer list acquisition profiles may be provided.

Still other programs may be additionally or alternatively provided by remote retailer 304 and returns server 306. For example, a first time buyer program may be implemented for customers falling within this category. In particular embodiments, the first time buyer program may include a timely, personalized return notification email sent within two to three days of the mailing of the return. The personalized message may thank the customer for their business and acknowledge that the item did not meet their expectations. The personalized message may include a retention-focused offer such as a promotion code for a ten percent discount on the customer's next purchase. The personalized message may also include a link back to the remote retailer's Internet site. Use of the promotions code by customers in the first-time buyer category may then be tracked by returns server 306 to provide additional return analytics. At least one benefit realized by a first time buyer program such as the one described includes increased retention among an at risk customer segment.

Another program that may be additionally or alternatively provided may include a store traffic program. For example, a customer requesting a return authorization or receiving a return notification may be provided with local store information. Thus, the customer may be encouraged to visit a local brick and mortar store of the retailer. Information provided by the customer through the web application or over the telephone during the customer's initial communication with remote retailer 304 or the returns service provider, such as zip code and/or address, may be used to determine a store local to the customer. Alternatively, customer information provided from remote retailer 304 to returns server 306 in a forward file may be used to determine a store local to the customer. In particular embodiments, a coupon useable at a particular location may be provided to the customer to encourage the customer to visit the brick and mortar store. Benefits realized by a store traffic program include increased store traffic and revenue, thereby providing an additional source of revenue for remote retailer 304.

In particular embodiments, return analytics may also be performed to provide reports describing customer behavior on a global basis. Returns server 306 may profile the customer transaction data relevant to a particular retailer 304 to determine a systemic linkage between return behavior and purchase behavior. Specifically, returns server 306 may use data from remote retailer 304 and identified returns of items by customers, like customer 302, to determine the linkage, if any, between customer retention, average order value, order frequency, and services provided by returns system 300. In particular embodiments, the reported return analytics may be organized by logical customer groupings.

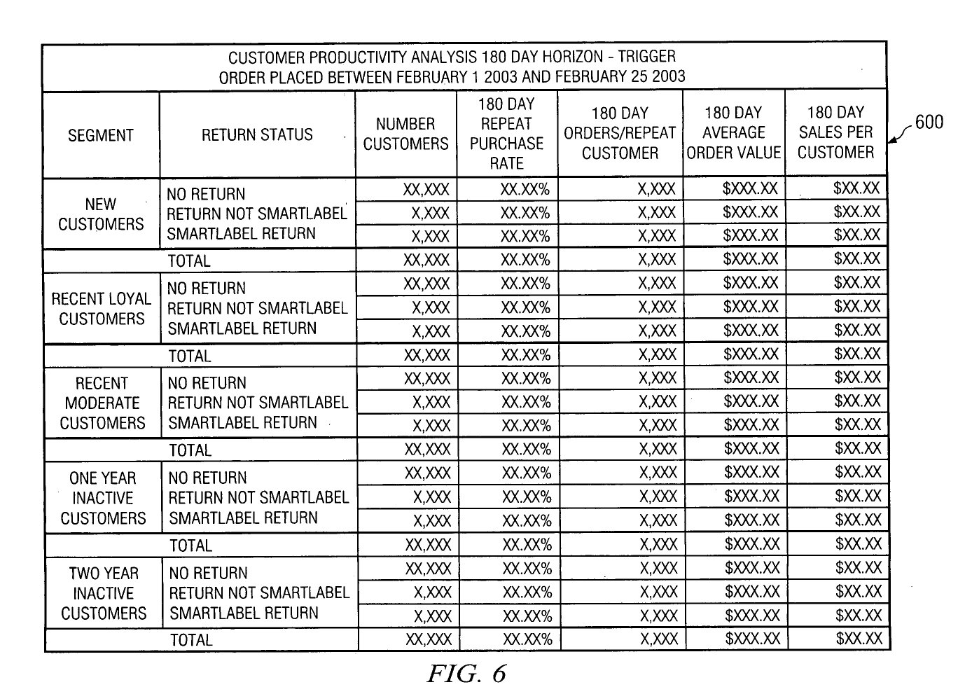

FIG. 6 depicts an exemplary return analytics report 600 that may be generated by returns server 306 to provide solid quantification of the impact of returns system 300 on customer loyalty. Remote retailer 304 may use report 600 to further integrate return services into the retailer's marketing agenda. Specifically, report 600 may be used to target offers to specific customer segments and execute returns-triggered offers in the same manner as described above with regard to FIG. 8. For example, the data may be used to trigger personalized email communications and offers.

In particular embodiments, customers are organized into customer segments. The customer segments profiled in report 600 include New Customers, Recent Loyal Customers, Recent Moderate Customers, 1 Year Inactive Customers, and 2 Year Inactive Customers. With respect to each of these customer segments, three return methods are profiled, including SmartLabel returners (i.e., customers using the return label 100 provided with encoded order, customer, retailer, and other information), non-SmartLabel returners, and non-returners. Three customer loyalty metrics are reported: repeat purchase rate, repeat orders, and average order value. These metrics are reported after a 180-day period from the customer's trigger order is received. Although only a 180-day time frame is illustrated, however, it is recognized that additional time frames may be utilized. In particular embodiments, customer activity may be measured over a 30-day period, a 60-day period, a 90-day period, and a 180-day period.

The data provided in report 600 may be used to compare loyalty impact across different customer segments and across different time frames. Returns server 306 may also use the data to compare return programs used by remote retailer 304. Thus, data may be included to quantify customer retention both prior to and after the implementation of returns system 300. The results of report 600 may also be used to target specific offers at customer segments to improve customer retention and customer satisfaction.

Shipping and Handling Fees

Various shipping and handling fee schemes may be applied to return package 12. Generally, the shipping and handling of return package 12 may be paid by customer 302 or paid by remote retailer 304. Where the fee is to be paid by the retailer, reverse manifesting is implemented and permits customer 302 to ship return package 12 with shipping charges due. Unlike conventional (forward) manifesting, return package 12 has already been shipped when it is manifested. In such a scenario, return label 100 may be provided to customer 302 at no additional charge. In particular embodiments where the returns service provider provides returns services to multiple retailers, return label 100 includes data useful for identifying remote retailer 304 and may contain other data particular to remote retailer 304. Return label 100 may direct return package 12 to centralized returns center 22 or to BMC 20 for pick-up by the returns service provider. The returns service provider assesses shipping charges, pays carrier 310, and passes the shipping cost on to remote retailer 304.

Alternatively, the shipping and handling fees may be paid by customer 302. In particular embodiments, return package 12 may be placed in transit with fees to be paid by the customer after shipping. Because fees are not paid in advance of shipping, this method may also be said to implement reverse manifesting. Again, customer 302 may be provided return label 100 using any of the methods described above for delivery. In this scenario, however, remote retailer 304 may deduct the costs of shipping from customer's credit for the returned item. Where an exchange is requested by customer 302, customer's credit card may be charged the additional shipping and handling fees for the returned item.

In other embodiments, centralized returns center 22 may charge customer 302 directly for the shipping and handling fees associated with return package 12. Thus, when centralized returns center 22 receives return package 12 (or when customer 302 requests return label 100), centralized returns center 22 may assess the shipping and handling charges, pay carrier 310, and debit the customer's credit card in the amount of the shipping and handling fee. In this manner, customer 302 may pay the returns service provider directly for handling the return of return package 12. The returns service provider may have customer's credit card information on file in relational database 308, or customer 302 may provide the customer's credit card information to returns server 306 when customer 302 requests return label 100 or return authorization. In particular embodiments, a portion of the fee collected from customer 302 may be remitted to remote retailer 304 where remote retailer 304 and the returns service provider have stipulated to such an arrangement.

Where customer 302 has a choice between using return label 100 provided by the returns service provider or simply taking return package 12 to the customer's local post office and placing it in the mail to be shipped directly to remote retailer 304, BMC 20, or centralized returns center 22, customer 302 may be charged a reduced shipping fee for choosing to ship with return label 100. Thus, where shipping through the USPS may cost customer 302 seven dollars, return label 100 may be offered to customer 302 for only six dollars. In this scenario, the additional one dollar of expense not paid for by customer 302 may be paid by remote retailer 304. However, the benefits that remote retailer 304 may obtain by the customer's use of return label 100 may outweigh the nominal expense to remote retailer 304. One such benefit may include improved customer retention resulting from the ease of the return process to customer 302. Other benefits may include return package tracking, advanced return notification, rules-based dispositioning, and return analytics. These services provided by returns server 306 allow remote retailer 304 better visibility of return package 12 through the return process and greater understanding of measurable return metrics.

Dynamic Pricing

The return analytics performed by returns server 306 may also be used as a factor in determining shipping and handling fees. As described above, various promotions may be provided to customer 302 based on the categorization of customer 302 relative to other customers of remote retailer 304. Other factors, in addition to or in lieu of customer status, may be used to implement a dynamic pricing scheme for determining shipping and handling fees. In particular embodiments, the dynamic pricing scheme may take into account customer location, weight of return package 12, the type of item(s) in return package 12, the value of the item(s) in return package 12, or the value of the customer's order. These factors may be considered when determining the price to customer 302 for shipping return package 12 back to remote retailer 304 or another destination of return package 12. Thus, where return package 12 is lighter than an average package or where return package 12 is not required to travel as far to get to BMC 20, centralized returns center 22, or final destination 24, the shipping charges paid by customer 302 may be reduced. Similarly, where the item is in high demand and a speedy return is beneficial to remote retailer 304, shipping and handling fees may be reduced. Accordingly, it is recognized that the shipping and handling fees may be assessed on a per-customer, per item, per return, or per retailer basis taking into account any number of factors that are relevant to remote retailer 304.

Although the present invention has been described in detail, it should be understood that various changes, substitutions and alterations can be made thereto without departing from the spirit and scope of the invention.

What is claimed is:

1. A method for the customized processing of returned merchandise comprising:
storing information associated with a customer in a database, the information comprising a returns history and a purchase transaction history of the customer;
analyzing at least one of the returns history and the purchase transaction history to determine at least one reportable parameter; and
categorizing the customer into at least one of a plurality of pre-defined customer segments based on the reportable parameter.

2. The method of claim 1, wherein categorizing the customer into the at least one customer segment comprises grouping the customer with a plurality of other customers sharing like characteristics.

3. The method of claim 1, wherein the at least one reportable parameter comprises a return rate.

4. The method of claim 1, wherein the at least one reportable parameter comprises a customer value.

5. The method of claim 1, further comprising selecting a marketing promotion to offer the customer based on the categorization of the customer into the at least one customer segment.

6. The method of claim 5, further comprising:
receiving additional information from the customer, the additional information comprising a request to return an item of merchandise;
communicating a message to the customer that includes the marketing promotion.

7. The method of claim 6, wherein:
categorizing the customer into the at least one customer segment comprises categorizing the customer into an elite buyer customer segment; and
communicating the message to the customer comprises communicating an offer to pay for the shipping of the item of merchandise.

8. The method of claim 6, wherein:
categorizing the customer into the at least one customer segment comprises categorizing the customer into a growth segment; and
communicating the message to the customer comprises communicating a survey to the customer to obtain more information about the return history of the customer.

9. The method of claim 6, wherein:
categorizing the customer into the at least one customer segment comprises categorizing the customer as a problem customer; and
the method further comprises removing the customer from a retailer's customer list to prevent the customer from receiving future promotions and advertising.

10. The method of claim 6, wherein:
categorizing the customer into the at least one customer segment comprises categorizing the customer into a first-time buyer category; and
the method further comprises selecting a marketing promotion to offer the customer based on the categorization of the customer into the first-time buyer category.

11. The method of claim 10, further comprising:
receiving additional information from the customer, the additional information comprising a request to return an item of merchandise;
communicating a message to the customer that includes the marketing promotion.

12. The method of claim 6, wherein the message comprises an offer for a reduction in return shipping fees by an amount that is determined based on the categorization of the customer.

13. The method of claim 1, further comprising communicating a message to the customer based on the categorization of the customer into the at least one customer segment, the message comprising an invitation to visit a store of a retailer that is local to the customer.

14. The method of claim 1, wherein:
each of the at least one categories comprises a plurality of customers;
the method further comprising performing return analytics to provide a report to a retailer that summarizes customer behavior for the plurality of customers on a global basis.

15. The method of claim 1, wherein categorizing the customer into the at least one customer segment comprises categorizing the customer based on at least one of an annual order value, a customer activity level, and a customer loyalty measure.

16. The method of claim 1, wherein categorizing the customer into the at least one customer segment comprises categorizing the customer based on whether the customer uses a particular return process for returning at least one item of unwanted merchandise.

17. A method for the customized processing of returned merchandise comprising:
storing customer and transaction information associated with a plurality of customers in a customer database;
storing a plurality of retailer-specific rules in a retailer database;
categorizing each of the plurality of customers into a plurality of pre-defined customer segments based on the customer and transaction information; and
communicating a message to a selected one of the plurality of customers based on the categorization of the selected customer in accordance with a retailer-specific rule.

18. The method claim 17, wherein:
the customer information identifies at least the names of the plurality of customers; and
the transaction information comprises a purchase transaction history summarizing one or more previous merchandise orders for each customer.

19. The method of claim 17, wherein the categorization of each of the plurality of customers into the customer segments is based on a return rate.

20. The method of claim 17, wherein the categorization of each of the plurality of customers into the customer segments is based on a customer value.

21. The method of claim 17, wherein communicating the message comprises communicating a marketing promotion to the customer.

22. The method of claim 17, further comprising:
receiving additional information from the selected customer before communicating the message to the selected customer, the additional information comprising a request to return an item of merchandise.

23. The method of claim 22, wherein:
categorizing the plurality of customers into the customer segments comprises categorizing the selected customer into an elite buyer customer segment; and
communicating the message to the selected customer comprises communicating an offer to pay for the return shipping of the item of merchandise.

24. The method of claim 22, wherein:
categorizing the plurality of customers into the customer segments comprises categorizing the selected customer into a growth segment; and
communicating the message to the selected customer comprises communicating a survey to obtain more information about the return history of the selected customer.

25. The method of claim 17, wherein:
categorizing the plurality of customers into the customer segments comprises categorizing the selected customer into a first-time buyer category.

26. The method of claim 17, further comprising performing return analytics to provide a report to a retailer that summarizes customer behavior for the plurality of customers on a global basis.

27. The method of claim 17, wherein each of the plurality of customers are categorized into a selected customer segment based on at least one of an annual order value, a customer activity level, and a customer loyalty measure.

28. The method of claim 17, wherein the message is communicated to the selected customer upon the occurrence of a triggering event.

29. The method of claim 17, wherein the message is communicated as a scheduled event.

30. A system for the customized processing of returned merchandise comprising:
a retailer communicatively coupled to a data network;
a returns server communicatively coupled to the data network, the returns server operable to receive customer and transaction information from the retailer and store the customer and transaction information in a database, the returns server comprising logic operable to:
identify a series of transaction events associated with a return process; and
perform the series of transaction events without human involvement upon the occurrence of a triggering event.

31. The system of claim 30, wherein the customer and transaction information is received from the retailer as a forward file; the returns server operable to store the customer and transaction information in the database before a return communication is received from a customer.

32. The system of claim 31, wherein the forward file is transmitted from the retailer to the returns server on a periodic basis.

33. The system of claim 31, wherein the forward file is downloaded, from a database associated with the retailer, by the returns server on a periodic basis.

34. The system of claim 31, wherein the forward file is transmitted from the retailer to the returns server on a real-time basis.

35. The system of claim 30, wherein the logic is further operable to convert the customer and transaction information from a first protocol to a second protocol.

36. The system of claim 30, wherein the logic is further operable to:
receive a returns communication; and
detect that the returns communication comprises a triggering event.

37. The system of claim 36, wherein:
the returns communication comprises a return authorization request for an item of merchandise; and
at least one of the series of transaction events comprises a return authorization response.

38. The system of claim 36, wherein:
the returns communication comprises a customer return communication identifying an item of merchandise for return; and
at least one of the series of transaction events comprises the initiation of a return process.

39. The system of claim 38, wherein the initiation of the return process comprises the generation of a return shipping label having machine readable data representing at least the identification of a retailer associated with the returned item.

40. The system of claim 39, wherein the machine readable data includes at least a purchase transaction identifier.

41. The system of claim 39, wherein the machine readable data includes an order number.

42. The system of claim 39, wherein the machine readable data includes a customer identifier.

43. The system of claim 39, wherein the machine readable data includes a product identifier.

44. The system of claim 39, wherein the machine readable data comprises at least one variable length barcode, the length of the at least one barcode determined by the retailer.

45. The system of claim 39, wherein the returns server is further operable to electronically communicate the shipping label to a customer using a web application.

46. The system of claim 39, wherein the returns server is further operable to electronically communicate the shipping label to a customer in an email.

47. The system of claim 39, wherein the returns server is further operable to fax the return label to the customer.

48. The system of claim 39, wherein the returns server is further operable to generate the return label for mailing to the customer.

49. The system of claim 39, wherein the logic is further operable to charge a credit account of the customer for return shipping fees associated with the return label.

50. The system of claim 39, wherein the return shipping fees associated with the return label are to be deducted from a refund amount remitted to the customer.

51. The system of claim 36, wherein:
the returns communication comprises scan information received from a shipping carrier, the scan information associated with a return package including an item of returned merchandise; and
at least one of the series of transaction events comprises providing status information to a retailer associated with the sale of the item of returned merchandise.

52. The system of claim 36, wherein:
the returns communication comprises scan information received from a shipping carrier, the scan information associated with a return package including an item of returned merchandise; and
at least one of the series of transaction events comprises providing status information to a customer associated with the item of returned merchandise.

53. The system of claim 36, wherein:
the returns communication comprises a customer returns communication requesting status information for an item of returned merchandise associated with a customer; and
at least one of the series of transaction events comprises providing status information to the customer.

54. The system of claim 36, wherein:
the returns communication comprises a customer returns communication identifying an item of merchandise for return from a customer; and
at least one of the series of transaction events comprises providing a personalized promotion to the customer.

55. The system of claim 30, wherein:
the returns server is further operable to store a retailer rule in the database identifying a triggering event and a transaction event to be performed; and
the logic further operable to:
detect the occurrence of the triggering event associated with the retailer rule; and
perform the transaction event

56. The system of claim 55, wherein:
the triggering event comprises a return communication received from a customer, the return communication identifying a item of merchandise; and
the transaction event comprises bypassing a returns process.

57. The system of claim 30, wherein the logic is further operable to categorize each of a plurality of customers into a plurality of pre-defined customer segments based on the customer and transaction information.

58. The system claim 57, wherein:
the customer information identifies at least the names of the plurality of customers; and
the transaction information comprises a purchase transaction history summarizing one or more previous merchandise orders for each customer.

59. The system of claim 57, wherein the categorization of each of the plurality of customers into the customer segments is based on a return rate.

60. The system of claim 57, wherein the categorization of each of the plurality of customers into the customer segments is based on a customer value.

61. The system of claim 57, wherein at least one of the series of transaction events comprises communicating a marketing promotion to a customer.

62. The system of claim 30, wherein at least one of the series of transaction events comprises communicating, to a customer, an offer to pay for a return shipping fee associated with an item of merchandise.

63. The system of claim 30, wherein at least one of the series of transaction events comprises communicating, to a customer, a survey to obtain more information from the customer.

64. The system of claim 30, wherein the logic is further operable to perform return analytics to provide a report to the retailer that summarizes customer behavior for a plurality of customers.

65. The system of claim 30, wherein the logic is further operable to categorize each of a plurality of customers into a plurality of pre-defined customer segments based on at least one of an annual order value, a customer activity level, and a customer loyalty measure.

66. The system of claim 30, wherein the triggering event is a scheduled event.

67. The system of claim 30, wherein the triggering event is the scanning of a return label associated with a return package.
